(19) United States
(12) Patent Application Publication
(10) Pub. No.: US 2021/0323124 A1
(43) Pub. Date: Oct. 21, 2021

(54) knife with rod sharpener inserted into handle

(71) Applicant: Robert Kowalczyk, Vero Beach, FL (US)

(72) Inventor: Robert Kowalczyk, Vero Beach, FL (US)

(21) Appl. No.: 17/064,858

(22) Filed: Oct. 7, 2020

Related U.S. Application Data
(63) Continuation-in-part of application No. 29/728,546, filed on Apr. 21, 2020.

(51) Int. Cl. B24D 15/08; B26B 9/00; B26B 11/00; B25G 1/08

(52) U.S. Cl. CPC B24D 15/084; B25G 1/08; B26B 11/00; B26B 9/00

(57) ABSTRACT

Disclosed is a knife with a Rod Sharpener inserted into the handle. The knife is comprised of a unique horseshoe style blade shape around an insert inside the handle. The handle is comprised of Rubber and Plastic. The rubber provides comfort for your hand when using and the plastic is used for stability of the handle. The removable piece is insertable into the handle. The actual rod is comprised of either ceramic or metal. The rod can be inserted or screwed into the handle.

With a background in the fishing industry, Robert Kowalczyk designed the Knife with a Rod sharpener that inserts into the handle making it a useful multi functional tool.

The unique design will be with a end piece that will insert into the handle. The sharpening tool will be a rod shape and will sit perfectly into the handle. The overall invention is that there is a handle and an end piece that will have a sharpening rod insertable into the shaft of the handle. The handle can be an insertable or screwable, attachable it will always have a sharpening rod and will always go into the handle. The inside will be waterproof. The Blade is horsehore shaped to fit around the tube of the rod sharpener inside the handle.

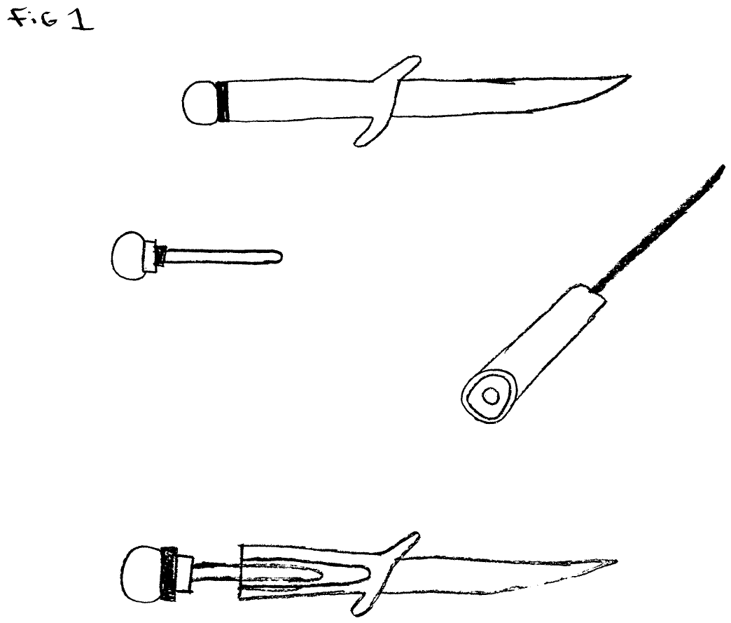

### DRAWING DESCRIPTIONS FIG. 1

A ceramic or metal rod that can be inserted or screwable into the handle of the knife The knife blade is curved in a horseshoe and goes around the tube of the rod insert

1. The Claim is for the Rod Sharpener to be inserted/ screwable into the handle. The overall sharpener can be inserted, screwable, attached in anyway to the Rod Sharpener and then inserted into the handle. The blades end is horseshoe shaped so it wraps around the inside of the rod tube and handle. The Rod sharpener material can be of Ceramic or metal. The Handle material can be of rubber, metal, or plastic material. the blade can be of any carbon steel material.
